(19) United States
(12) Patent Application Publication
(10) Pub. No.: US 2019/0087873 A1
(43) Pub. Date: Mar. 21, 2019

(54) CAPTURING SENSOR INFORMATIONFOR VALIDATING A PRODUCT REVIEW

(71) Applicant: INTERNATIONAL BUSINESS MACHINES CORPORATION, Armonk, NY (US)

(72) Inventors: Slade Baumann, Rochester, MN (US); James E. Carey, Rochester, MN (US); Jacob Gregor, Rochester, MN (US); Ryan L. Rossiter, Rochester, MN (US)

(21) Appl. No.: 15/708,650

(22) Filed: Sep. 19, 2017

(51) Int. Cl. G06Q 30/02; G06Q 10/00; G06Q 30/00

(52) U.S. Cl. CPC G06Q 30/0282; G06Q 30/018; G06Q 10/20

(57) ABSTRACT

An approach is provided for transferring a message. A review is received. The review has content that specifies an aspect of a subject having multiple aspects. A reviewer provides the review. Information collected by sensor(s) is retrieved, where the information is about actual usage of the aspect by the reviewer. It is determined whether the content specifying the aspect of the product matches the retrieved information about the actual usage of the aspect of the product by the reviewer. If the content matches the retrieved information, an indicator that indicates the content specifying the aspect of the product is accurate is generated and transferred, or if the content does not match the retrieved information, an indicator that indicates the content specifying the aspect of the product is inaccurate is generated and transferred.

### BACKGROUND

The present invention relates to managing captured sensor information, and more particularly to using captured sensor information to validate a product review.

A reviewer of a product having multiple aspects may include comments in a review that are critical or appreciative of certain aspects of the product. A disingenuous reviewer authors and posts a fraudulent review that comments on usage of an aspect of a product which states or suggests that the reviewer has used the aspect in question, but the reviewer has not actually used the aspect, or that the reviewer frequently uses the aspect in question, but in fact uses the aspect infrequently.

Known monitoring systems such as smart home sensor technologies using Internet of Things devices may include sensors that detect usage of products that are reviewed and collect detailed information about the usage, including who uses aspects of the products, and when and how aspects of the products are used.

### SUMMARY

In one embodiment, the present invention provides a method of transferring a message. The method includes a computer receiving a review whose content specifies an aspect of a subject having multiple aspects. The review is provided by a reviewer. The method further includes the computer retrieving information collected by one or more sensors about actual usage of the aspect of the subject by the reviewer. The method further includes the computer determining whether the content specifying the aspect of the subject matches the retrieved information about the actual usage of the aspect of the subject by the reviewer. The method further includes (i) if the content specifying the aspect of the subject matches the retrieved information about the actual usage of the aspect of the subject by the reviewer, the computer generating and transferring an indicator that indicates the content specifying the aspect of the subject is accurate, or (ii) if the content specifying the aspect of the subject does not match the retrieved information about the actual usage of the aspect of the subject by the reviewer, the computer generating and transferring an indicator that indicates the content specifying the aspect of the subject is inaccurate.

In another embodiment, the present invention provides a computer program subject including a computer readable storage medium and computer readable program code stored in the computer readable storage medium. The computer readable program code contains instructions that are executed by a central processing unit (CPU) of a computer system to implement a method of transferring a message. The method includes the computer system receiving a review whose content specifies an aspect of a subject having multiple aspects. The review is provided by a reviewer. The method further includes the computer system retrieving information collected by one or more sensors about actual usage of the aspect of the subject by the reviewer. The method further includes the computer system determining whether the content specifying the aspect of the subject matches the retrieved information about the actual usage of the aspect of the subject by the reviewer. The method further includes (i) if the content specifying the aspect of the subject matches the retrieved information about the actual usage of the aspect of the subject by the reviewer, the computer system generating and transferring an indicator that indicates the content specifying the aspect of the subject is accurate, or (ii) if the content specifying the aspect of the subject does not match the retrieved information about the actual usage of the aspect of the subject by the reviewer, the computer system generating and transferring an indicator that indicates the content specifying the aspect of the subject is inaccurate.

In another embodiment, the present invention provides a computer system including a central processing unit (CPU); a memory coupled to the CPU; and a computer readable storage medium coupled to the CPU. The computer readable storage medium contains instructions that are executed by the CPU via the memory to implement a method of transferring a message. The method includes the computer system receiving a review whose content specifies an aspect of a subject having multiple aspects. The review is provided by a reviewer. The method further includes the computer system retrieving information collected by one or more sensors about actual usage of the aspect of the subject by the reviewer. The method further includes the computer system determining whether the content specifying the aspect of the subject matches the retrieved information about the actual usage of the aspect of the subject by the reviewer. The method further includes (i) if the content specifying the aspect of the subject matches the retrieved information about the actual usage of the aspect of the subject by the reviewer, the computer system generating and transferring an indicator that indicates the content specifying the aspect of the subject is accurate, or (ii) if the content specifying the aspect of the subject does not match the retrieved information about the actual usage of the aspect of the subject by the reviewer, the computer system generating and transferring an indicator that indicates the content specifying the aspect of the subject is inaccurate.

Embodiments of the present invention validate product reviews to detect fraudulent reviews and present reviews that are likely to be trustworthy. Embodiments of the present invention provide a crowd-sourced validation of malfunctioning part(s) of a product which may be used by a manufacturer of the product to identify and fix defect(s) in the product, where the defect(s) cause the malfunctioning of the part(s).

### BRIEF DESCRIPTION OF THE DRAWINGS

FIG. 1 is a block diagram of a system for validating a review of a product, in accordance with embodiments of the present invention.

FIG. 2 is a flowchart of a process of validating a review of a product, where the process is implemented by the system of FIG. 1, in accordance with embodiments of the present invention.

FIG. 3 is a flowchart of a process of validating a malfunction of a part of a product via crowd sourcing, where the process is implemented by the system of FIG. 1, in accordance with embodiments of the present invention.

FIG. 4 is a block diagram of a computer that is included in the system of FIG. 1 and that implements the processes of FIG. 2 and FIG. 3, in accordance with embodiments of the present invention.

### DETAILED DESCRIPTION

### Overview

Embodiments of the present invention transfer a message to validate a review of an aspect of a subject by determining information about actual usage (or a lack of actual usage) of the subject by a person who authored the review. In one embodiment, the subject is a product, which is a manufactured item. Whether a review of an aspect of a product is fraudulent may be based on the information about the usage of the aspect of the product. Multiple reviews of a product by different reviewers may provide a manufacturer of the product with crowd-sourced data about a malfunctioning part of a product. The manufacturer of the product may utilize the crowd-sourced data to identify and fix defect(s) in the product.

### System for Validating a Review of a Product

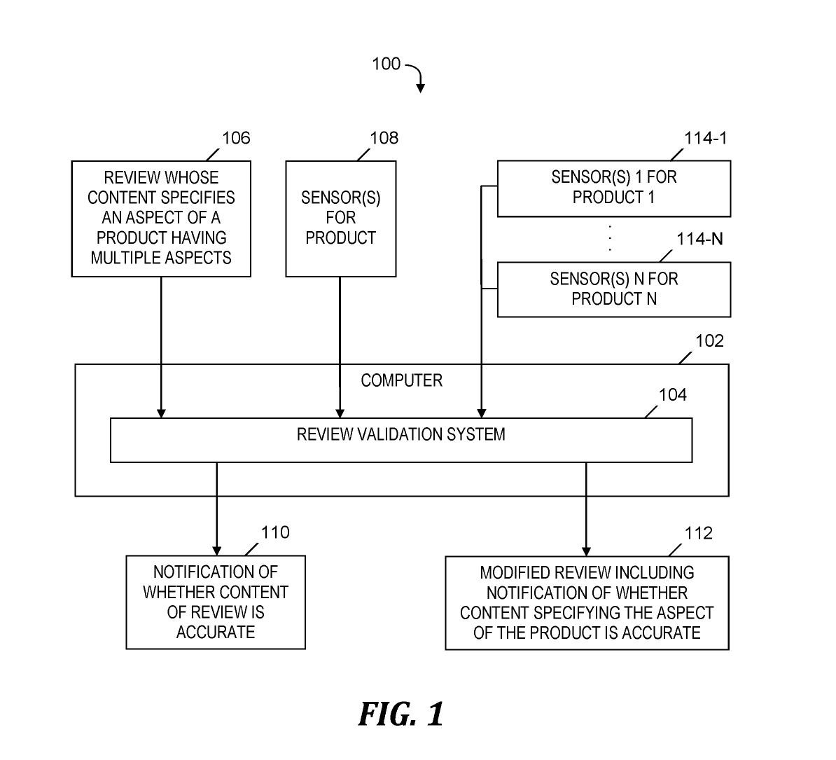

FIG. 1 is a block diagram of a system 100 for validating a review of a product, in accordance with embodiments of the present invention. System 100 includes a computer 102, which executes a software-based review validation system 104, which receives review 106 whose content specifies and comments upon an aspect of a product having multiple aspects. As used herein, an aspect of a product is a part of the product or a technical feature of the product which has a functionality that is more specific than an overall functionality of the product. A human reviewer authors and provides review 106 to review validation system 104, where the authoring of review 106 utilizes a computer (i.e., computer 102 or another computer, not shown). The reviewer may utilize a computer (i.e., computer 102 or another computer, not shown) to post review 106 to a website that provides a service that allows users to post and view reviews of products, where the website may also include review validation system 104.

Sensor(s) 108 are operatively coupled to computer 102 via computer network(s) (not shown). Sensor(s) 108 monitor and collect information about usage by the reviewer of an aspect of the product to which review 106 is directed. In one embodiment, the information about usage includes timestamps indicating when, how many times, and the frequency that the reviewer used the aspect of the product. Sensor(s) 108 send the monitored and collected information about usage to review validation system 104. In one embodiment, sensor(s) 108 are included in the product, which is a connected device or an Internet of Things device.

Review validation system 104 determines whether the content of review 106 that specifies and comments upon the aspect of the product is accurate or inaccurate. Review validation system 104 generates a notification 110 that designates the aforementioned content of review 106 as being accurate or inaccurate. In one embodiment, review validation system 104 modifies review 106 to generate a modified review 112, which includes notification 110. In one embodiment, review validation system 104 displays modified review 112 instead of review 106 to users who utilize review validation system 104 to view reviews of the product, which makes the viewed review (i.e., modified review 112) more trustworthy or more informative to the users because its accuracy or lack of accuracy is displayed to the users.

In one embodiment, review validation system 104 uses text analysis of review 106 and a comparison of the usage information to a predetermined threshold of usage amount or usage frequency to determine a confidence level indicating whether the content in review 106 that specifies the aspect of the product is supported by actual usage of the product by the reviewer as indicated by the usage information derived from sensor(s) 108. In one embodiment, review validation system 104 saves in a data repository (not shown) the aforementioned usage information in a profile of the product.

Review validation system 104 also receives information from sensor(s) 114-1, . . . , sensor(s) 114-N about usage of N products, respectively, where N is an integer greater than or equal to one, and where each of the N products matches the product to which review 106 is directed. In one embodiment, a product matching the product to which review 106 is directed means that the products are the same make and model and include the same aspect which is specified in the content of review 106. Review validation system 104 may use usage information from sensor(s) 114-1, sensor(s) 114-N as a crowd sourcing technique to support the accuracy of content in review 106 that identifies a malfunction of a part of a product, even though other reviews of N products whose usage is monitored by sensor(s) 114-1, sensor(s) 114-N, respectively, may not mention a malfunction of the same part. In one embodiment, using the crowd sourcing technique provided by the usage information from sensor(s) 114-1, sensor(s) 114-N, review validation system 104 generates and sends a notification (not shown) to the manufacturer of the product about the multiple instances of the malfunctioning part, which results in the manufacturer identifying and fixing a defect in the product that caused the malfunctioning part.

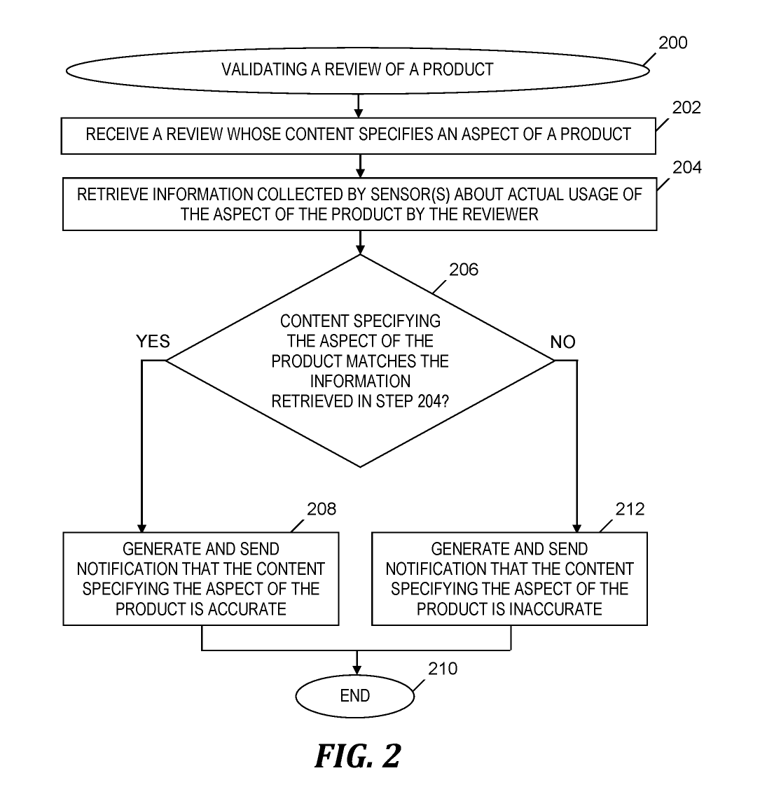

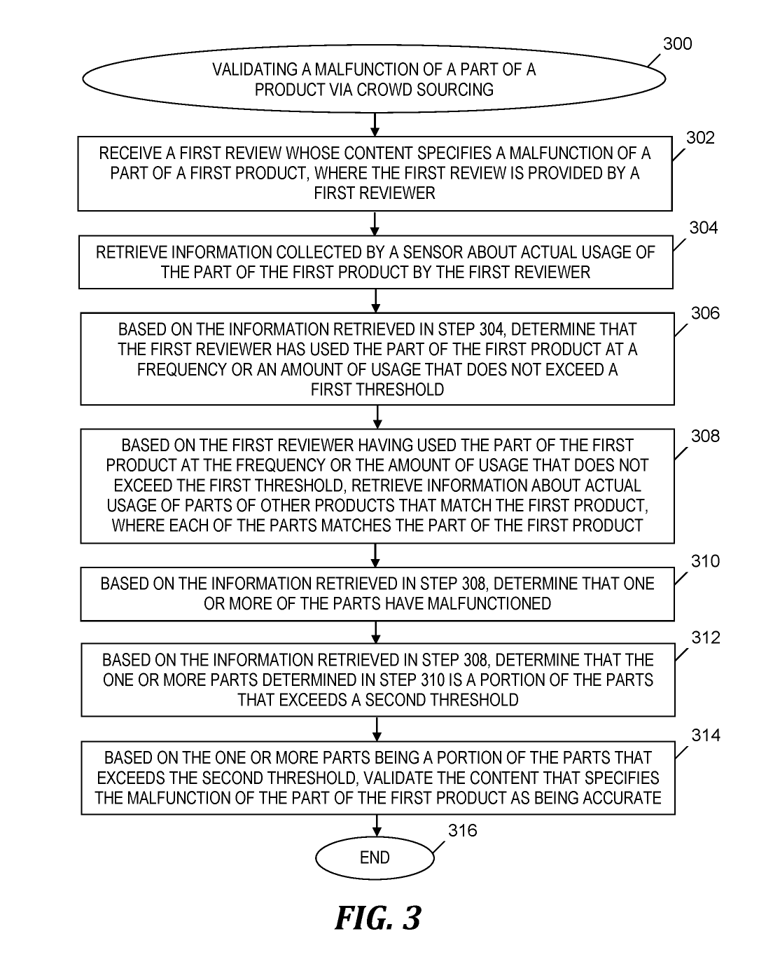

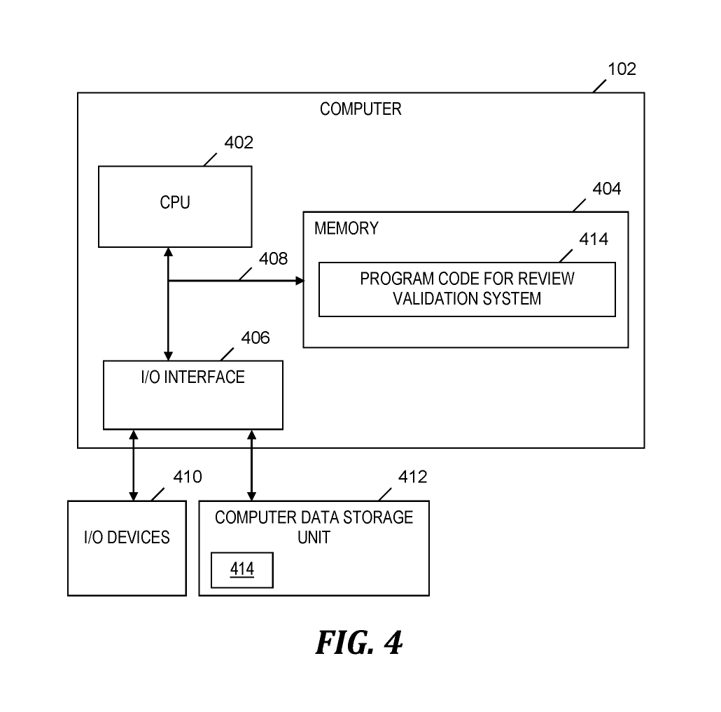

The functionality of the components shown in FIG. 1 is described in more detail in the discussion of FIG. 2, FIG. 3, and FIG. 4 presented below.

### Process for Validating a Review of a Product

FIG. 2 is a flowchart of a process of validating a review of a product, where the process is implemented by the system of FIG. 1, in accordance with embodiments of the present invention. The process of FIG. 2 begins at step 200. In step 202, review validation system 104 (see FIG. 1) receives a review (i.e., review 106 in FIG. 1) of a product, where the content of the review specifies and comments upon an aspect of the product, and where the review is authored by a reviewer. For example, review validation system 104 (see FIG. 1) receives a review that specifies that a part of a product has malfunctioned on multiple occasions. In one embodiment, the content specifying the aspect of the product includes content that specifies that usage of the product is affected by an aspect of the environment (e.g., lighting conditions) in which the product is used by the reviewer. Hereinafter, in the discussion of FIG. 2, the product which is the subject of the review received in step 202 is also referred to as “the product,” the aspect specified by the content of the review received in step 202 is also referred to as “the aspect,” the content of the review that specifies and comments upon the aspect is also referred to as “the content,” and the reviewer who authored the review received in step 202 is also referred to as “the reviewer.”

In step 204, review validation system 104 (see FIG. 1) retrieves information (also referred to herein as usage information) collected by sensor(s) 108 (see FIG. 1) about actual usage of the aspect of the product by the reviewer. In one embodiment, the aspect is a part of the product that has a specific function. In another embodiment, the aspect is a technical feature of the product that provides a specific function. In one embodiment, the usage information includes information about an aspect of the environment (e.g., lighting conditions) in which the product is being used by the reviewer. For example, sensor(s) 108 (see FIG. 1) includes a light sensor that determines the lighting conditions to which the product is exposed during its use.

In one embodiment, retrieving the usage information in step 204 includes review validation system 104 (see FIG. 1) retrieving the usage information from (i) a server that has access to the usage information collected by sensor(s) 108 (see FIG. 1) prior to a receipt of a request to view the review, where the server stores the review in association with the information collected by sensor(s) 108 (see FIG. 1), (ii) a web site managing reviews, where the usage information is made available to the website via a callback which is executed in response to the receipt of the request to view the review, or (iii) the website managing the reviews, where the usage information is supplied to the website by computer 102 (see FIG. 1) or another computer in response to a retrieval of the usage information from sensor(s) 108 (see FIG. 1) by computer 102 (see FIG. 1) or the other computer in response to the reviewer utilizing computer 102 (see FIG. 1) or the other computer to generate or post the review on the website.

In step 206, review validation system 104 (see FIG. 1) determines whether the content specifying the aspect of the product matches the usage information retrieved in step 204. If review validation system 104 (see FIG. 1) determines in step 206 that the content specifying the aspect of the product matches the usage information retrieved in step 204, then the Yes branch of step 206 is taken and step 208 is performed. The content being determined to match the usage information in step 206 means that the aspect specified and commented upon by the content was actually used by the reviewer, as indicated by the usage information retrieved in step 204.

In step 208, review validation system 104 (see FIG. 1) designates the content specifying the aspect of the product as being accurate (i.e., the content is likely not fraudulent). In one embodiment, review validation system 104 (see FIG. 1) in step 208 generates and sends a notification that the content specifying the aspect of the product is accurate. In one embodiment, review validation system 104 (see FIG. 1) adds the notification generated in step 208 to modify review 106 (see FIG. 1), which results in modified review 112 (see FIG. 1), which is viewed by other users of review validation system 104 (see FIG. 1), instead of review 106 (see FIG. 1), which results in the other users having a greater level of trust in modified review 112 (see FIG. 1).

Following step 208, the process of FIG. 2 ends at step 210.

Returning to step 206, if review validation system 104 (see FIG. 1) determines that the content does not match the usage information retrieved in step 204, then the No branch of step 206 is taken and step 212 is performed.

In step 212, review validation system 104 (see FIG. 1) designates the content specifying the aspect of the product as being inaccurate (i.e., the content is likely to be fraudulent). In one embodiment, review validation system 104 (see FIG. 1) generates and sends a notification that the content is not accurate. In one embodiment, review validation system 104 (see FIG. 1) adds the notification generated in step 212 to modify review 106 (see FIG. 1), which results in modified review 112 (see FIG. 1), which is viewed by other users of review validation system 104 (see FIG. 1) instead of review 106 (see FIG. 1), which results in the other users having a lesser level of trust in modified review 112 (see FIG. 1) because it includes content that is not accurate.

Following step 212, the process of FIG. 2 ends at step 210.

In one embodiment, the review received in step 202 includes content that specifies a usage and a subsequent malfunction of a part of the product and the usage information retrieved in step 204 indicates that the reviewer has not actually used the part. In step 206, review validation system 104 (see FIG. 1) determines that the content of the review regarding the malfunctioning part does not match the usage information which indicates that the reviewer has not used the part. In step 212, review validation system 104 (see FIG. 1) designates the content specifying the malfunctioning part as being inaccurate.

As one example, in step 202, review validation system 104 (see FIG. 1) receives review 106 (see FIG. 1) provided by a reviewer, where the review is about a refrigerator and includes a comment that complains about the ice machine (i.e., ice maker) of the refrigerator becoming jammed. The reviewer gives the refrigerator a low rating as part of the review. In step 204, review validation system 104 (see FIG. 1) determines that the review includes a negative comment about the ice maker and in response, retrieves information from sensor(s) 108 (see FIG. 1) about the reviewer's usage of the ice machine. In step 206, review validation system 104 (see FIG. 1) determines from the retrieved usage information regarding the ice machine that the reviewer never turned the ice machine on (i.e., the ice machine complaint does not match the retrieved usage information), and in response designates the review as being fraudulent.

As another example, in step 202, review validation system 104 (see FIG. 1) receives review 106 (see FIG. 1) provided by a reviewer, where the review is about a tablet and includes a comment that complains that the tablet is terrible for reading e-books in bright areas (e.g., areas exposed to bright sunlight). In step 204, review validation system 104 (see FIG. 1) determines that the review includes the complaint about the difficulty in using the tablet to read e-books in bright areas and in response, retrieves information from sensor(s) 108 (see FIG. 1) about the reviewer's usage of the tablet and the environment of the tablet when it is being used by the reviewer. The information about the environment includes information from a light sensor that indicates a level of brightness to which the tablet is exposed during the reviewer's use of the tablet. In step 206, review validation system 104 (see FIG. 1) determines from the retrieved information regarding the usage of the tablet by the reviewer and the retrieved information about the environment of the tablet that (i) the reviewer used the tablet in dark areas, but never used the tablet in bright areas, and (ii) the reviewer uses the tablet only to watch moves and play game, never to read an e-book. In response to determining that the reviewer never used the tablet in bright areas and never used the tablet to read an e-book, review validation system 104 (see FIG. 1) designates the review as being fraudulent.

In another version of the previous example in which review validation system 104 (see FIG. 1) receives the same review having the same complaint about the difficulty in using the tablet to read e-books in bright areas, review validation system 104 (see FIG. 1) determines from the retrieved information about usage and lighting conditions that the reviewer has spent 1000 hours reading e-books in sunny conditions, and in response, designates the review as being accurate (i.e., not fraudulent).

In an alternate embodiment, following step 202, review validation system 104 (see FIG. 1) determines that the review is directed to a specific type of use of the product, determines that the specific type of use includes a use of a first part or a first feature of the product, and determines that the review is also directed to a second part or a second feature of the product. Review validation system 104 (see FIG. 1) also determines that the specific type of use does not include a use of the second part or the second feature of the product. Review validation system 104 (see FIG. 1) adds to a profile of the product at least a portion of the review to a description associated with the second part or second feature, and restricts modification of the profile so that a description of the second part or second feature is protected, at least in part, from modification. Review validation system 104 (see FIG. 1) determines one or more parts or features of the product that are not performing as expected based, at least in part, on the profile (i.e., performing below a threshold). Review validation system 104 (see FIG. 1) sends to a manufacturer of the product a notification that the one or more parts or features of the product are performing below the threshold. Review validation system 104 (see FIG. 1) analyzes the profile of the product and uses the profile to verify that (i) a part or a feature of the product is performing as expected, (ii) the type of use utilized by a user who has authored a review about the product, and (iii) one or more aspects of the product included in another review authored by a different user.

### Process for Validating a Malfunction of a Part of a Product Via Crowd Sourcing

FIG. 3 is a flowchart of a process of validating a malfunction of a part of a product via crowd sourcing, where the process is implemented by the system of FIG. 1, in accordance with embodiments of the present invention. The process of FIG. 3 begins at step 300. In one embodiment, the process of FIG. 3 is performed before the process of FIG. 2. In another embodiment, the process of FIG. 3 is performed after the process of FIG. 2. In step 302, review validation system 104 (see FIG. 1) receives a first review (i.e., review 106 in FIG. 1) whose content specifies a malfunction of a part of a first product. The first review is provided by a first reviewer.

In step 304, review validation system 104 (see FIG. 1) retrieves information collected by a sensor included in sensor(s) 108 (see FIG. 1), where the information is about actual usage of the part of the first product by the first reviewer.

In step 306, based on the information retrieved in step 304, review validation system 104 (see FIG. 1) determines that the first reviewer has used the part of the first product at a frequency or an amount of usage that does not exceed a first threshold regarding frequency or amount of usage.

In step 308, based on the first reviewer having used the part of the first product at the frequency or the amount of usage that does not exceed the first threshold, review validation system 104 (see FIG. 1) retrieves information about actual usage of parts of other products, where each of the other products match the first product (i.e., the other products share the same make and model as the first product), and where each of the parts matches the part of the first product (i.e., the other parts have the same function as the part of the first product).

In step 310, based on the information retrieved in step 308, review validation system 104 (see FIG. 1) determines that one or more parts included in the set of aforementioned parts of the other products have malfunctioned.

In step 312, based on the information retrieved in step 308, review validation system 104 (see FIG. 1) determines that the one or more parts determined in step 310 is a portion (e.g., a percentage or a fraction) of the aforementioned parts of the other products that exceeds a second threshold, thereby indicating a pattern of the part malfunctioning in a substantial number of the other products.

In step 314, based on the one or more parts being a portion of the aforementioned parts of the other products that exceeds the second threshold, review validation system 104 (see FIG. 1) validating the content of the first review that specifies the malfunction of the part of the first product as being accurate. In one embodiment, review validation system 104 (see FIG. 1) generates and sends a notification to a manufacturer of the first product and the other products about the part malfunctioning, which results in an identification and a repair of a defect in one or more products that match the first product, where the defect caused the part to malfunction in the first product.

The process of FIG. 3 ends at step 316.

For example, in step 302, review validation system 104 (see FIG. 1) receives review 106 (see FIG. 1) provided by a reviewer, where the review is about a refrigerator and includes a comment that complains about the ice machine of the refrigerator becoming jammed. In step 304, review validation system 104 (see FIG. 1) retrieves usage information about the reviewer's actual usage of the ice machine. In step 306, based on the retrieved usage information about the reviewer's usage of the ice machine, review validation system 104 (see FIG. 1) determines that the reviewer has used the ice machine, the ice machine has jammed, but the reviewer has not used the ice machine extensively (i.e., the reviewer's amount of usage of the ice machine does not exceed the first threshold referenced in step 306). In step 308, review validation system 104 (see FIG. 1) requests information from other refrigerators about usage of the refrigerators' ice machines, where the other refrigerators are the same model as the reviewer's refrigerator. In step 310, review validation system 104 (see FIG. 1) determines that 50% of the other refrigerators' ice machines have jammed, but none of the users of the other refrigerators reported the jamming issue. In step 312, review validation system 104 (see FIG. 1) determines that the 50% of ice machines jamming determined in step 310 exceeds the second threshold referenced in step 312, and in response validates the reviewer's complaint about the ice machine, even though the reviewer's usage of the ice machine was not extensive.

### Computer System

FIG. 4 is a block diagram of a computer that is included in the system of FIG. 1 and that implements the processes of FIG. 2 and FIG. 3, in accordance with embodiments of the present invention. Computer 102 is a computer system that generally includes a central processing unit (CPU) 402, a memory 404, an input/output (I/0) interface 406, and a bus 408. Further, computer 102 is coupled to I/0 devices 410 and a computer data storage unit 412. CPU 402 performs computation and control functions of computer 102, including executing instructions included in program code 414 to perform a method of validating a review of a product, where the instructions are executed by CPU 402 via memory 404. CPU 402 may include a single processing unit, or be distributed across one or more processing units in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes a known computer-readable storage medium, which is described below. In one embodiment, computer data storage unit 412 is a non-volatile data storage device, such as a magnetic disk drive (i.e., hard disk drive) or an optical disc drive (e.g., a CD-ROM drive which receives a CD-ROM disk).

Memory 404 and/or computer data storage unit 412 may store computer program code 414 that includes instructions that are executed by CPU 402 via memory 404 to validate a review of a product. Although FIG. 4 depicts memory 404 as including program code, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

Computer data storage unit 412 and/or one or more other computer data storage units (not shown) that are coupled to computer 102 may store review 106 (see FIG. 1), notification 110 (see FIG. 1), modified review 1112 (see FIG. 1), usage information collected from sensor(s) 108, and usage information collected from sensor(s) 114-1, sensor(s) 114-N (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to validating a review of a product. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to validate a review of a product. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of validating a review of a product.

While it is understood that program code 414 for validating a review of a product may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of validating a review of a product. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2 and FIG. 3) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of transferring a message, the method comprising the steps of:
a computer receiving a review whose content specifies an aspect of a subject having multiple aspects, the review being provided by a reviewer;
the computer retrieving information collected by one or more sensors about actual usage of the aspect of the subject by the reviewer;
the computer determining whether the content specifying the aspect of the subject matches the retrieved information about the actual usage of the aspect of the subject by the reviewer; and
if the content specifying the aspect of the subject matches the retrieved information about the actual usage of the aspect of the subject by the reviewer, the computer generating and transferring an indicator that indicates the content specifying the aspect of the subject is accurate, or if the content specifying the aspect of the subject does not match the retrieved information about the actual usage of the aspect of the subject by the reviewer, the computer generating and transferring an indicator that indicates the content specifying the aspect of the subject is inaccurate.

2. The method of claim 1, further comprising the steps of:
the computer receiving a first review whose content specifies a malfunction of a part of a first subject, the first review being provided by a first reviewer;
the computer retrieving information collected by a sensor about actual usage of the part of the first subject by the first reviewer;
based on the retrieved information about the actual usage of the part of the first subject by the first reviewer, the computer determining the first reviewer has used the part of the first subject at a frequency or an amount of usage that does not exceed a first predetermined threshold, which initially indicates that the content that specifies the malfunction is not accurate;
based on the first reviewer having used the part of the first subject at the frequency or the amount of usage that does not exceed the first predetermined threshold, the computer retrieving information about actual usage of parts of other subjects that match the first subject, wherein each of the parts matches the part of the first subject;
based on the retrieved information about the actual usage of the parts of the other subjects, the computer determining that one or more parts included in the parts have malfunctioned and determining that the one or more parts is a portion of the parts that exceeds a second predetermined threshold; and
based on the one or more parts being a portion of the parts that exceeds the second predetermined threshold, the computer validating the content that specifies the malfunction of the part of the first subject as being accurate, even though the first reviewer has used the part of the first subject at the frequency or the amount of usage that does not exceed the first predetermined threshold, which initially indicated that the content that specifies the malfunction was not accurate.

3. The method of claim 2, further comprising the step of in response to the step of validating the content that specifies the malfunction as being accurate, the computer generating and sending a notification to a manufacturer of the first subject about the part and the one or more parts having malfunctioned, which results in an identification and a repair of a defect that caused the part and the one or more parts to malfunction.

4. The method of claim 1, further comprising the computer designating that the content specifying a part of the subject is inaccurate, wherein the part is the aspect of the subject, wherein the step of receiving the review includes receiving the content which specifies that the part of the subject has malfunctioned on multiple occasions, wherein the step of retrieving the information about the actual usage of the aspect of the subject by the reviewer includes retrieving information collected by a sensor coupled to the subject which indicates that the reviewer has not actually used the part, wherein the step of determining whether the content specifying the aspect matches the retrieved information about the actual usage of the aspect of the subject by the reviewer includes determining that the content which specifies that the part of the subject has malfunctioned does not match the retrieved information which indicates that the reviewer has not actually used the part, and wherein the step of designating that the content specifying the part is inaccurate is based on the content which specifies that the part of the subject has malfunctioned not matching the retrieved information which indicates that the reviewer has not actually used the part.

5. The method of claim 1, further comprising the steps of:
the computer receiving a second review whose content specifies usage by a second reviewer of the subject is affected by an aspect of an environment of the subject;
the computer retrieving information collected a sensor about the aspect of the environment of the subject during actual usage of the subject by the second reviewer;
the computer determining whether the content specifying the usage of the subject being affected by the aspect of the environment matches the retrieved information about the aspect of the environment during the actual usage of the subject by the second reviewer; and
if the content specifying the usage of the subject being affected by the aspect of the environment matches the retrieved information about the aspect of the environment during the actual usage of the subject by the second reviewer, the computer generating and transferring an indicator that indicates the content specifying the usage of the subject being affected by the aspect of the environment is accurate, or if the content specifying the usage of the subject being affected by the aspect of the environment does not match the retrieved information about the aspect of the environment during the actual usage of the subject by the second reviewer, the computer generating and transferring an indicator that indicates the content specifying the usage of the subject being affected by the aspect of the environment is inaccurate.

6. The method of claim 5, further comprising the step of the computer presenting to a user the review together with (i) a first notification based on the indicator that indicates the content specifying the usage of the subject being affected by the aspect of the environment is accurate if the content specifying the usage of the subject being affected by the aspect of the environment matches the retrieved information about the aspect of the environment during the actual usage of the subject by the second reviewer or (ii) a second notification based on the indicator that indicates the content specifying the usage of the subject being affected by the aspect of the environment is inaccurate if the content specifying the usage of the subject being affected by the aspect of the environment does not match the retrieved information about the aspect of the environment during the actual usage of the subject by the second reviewer.

7. The method of claim 1, wherein the step of retrieving the information collected by the one or more sensors includes retrieving the information from (i) a server that has access to the information collected by the one or more sensors prior to a receipt of a request to view the review, wherein the server stores the review in association with the information collected by the one or more sensors, (ii) a website managing reviews, wherein the information is made available to the website via a callback which is executed in response to the receipt of the request to view the review, or (iii) the website managing the reviews, wherein the information is supplied to the website by the computer or another computer in response to a retrieval of the information from the one or more sensors by the computer or the other computer in response to the reviewer utilizing the computer or the other computer to generate or post the review on the website.

8. The method of claim 1, further comprising the step of:
providing at least one support service for at least one of creating, integrating, hosting, maintaining, and deploying computer readable program code in the computer, the program code being executed by a processor of the computer to implement the steps of receiving the review, retrieving the information, determining whether the content specifying the aspect of the subject matches the retrieved information about the actual usage of the aspect of the subject by the reviewer, and (i) generating and transferring an indicator that indicates the content specifying the aspect of the subject is accurate if the content specifying the aspect of the subject matches the retrieved information about the actual usage of the aspect of the subject by the reviewer, or (ii) generating and transferring an indicator that indicates the content specifying the aspect of the subject is inaccurate if the content specifying the aspect of the subject does not match the retrieved information about the actual usage of the aspect of the subject by the reviewer.

9. A computer program subject, comprising:
a computer readable storage medium and a computer readable program code stored in the computer readable storage medium, the computer readable program code containing instructions that are executed by a central processing unit (CPU) of a computer system to implement a method of transferring a message, the method comprising the steps of:
the computer system receiving a review whose content specifies an aspect of a subject having multiple aspects, the review being provided by a reviewer;
the computer system retrieving information collected by one or more sensors about actual usage of the aspect of the subject by the reviewer;
the computer system determining whether the content specifying the aspect of the subject matches the retrieved information about the actual usage of the aspect of the subject by the reviewer; and
if the content specifying the aspect of the subject matches the retrieved information about the actual usage of the aspect of the subject by the reviewer, the computer system generating and transferring an indicator that indicates the content specifying the aspect of the subject is accurate, or if the content specifying the aspect of the subject does not match the retrieved information about the actual usage of the aspect of the subject by the reviewer, the computer system generating and transferring an indicator that indicates the content specifying the aspect of the subject is inaccurate.

10. The computer program subject of claim 9, wherein the method further comprises the steps of:
the computer system receiving a first review whose content specifies a malfunction of a part of a first subject, the first review being provided by a first reviewer;
the computer system retrieving information collected by a sensor about actual usage of the part of the first subject by the first reviewer;
based on the retrieved information about the actual usage of the part of the first subject by the first reviewer, the computer system determining the first reviewer has used the part of the first subject at a frequency or an amount of usage that does not exceed a first predetermined threshold, which initially indicates that the content that specifies the malfunction is not accurate;
based on the first reviewer having used the part of the first subject at the frequency or the amount of usage that does not exceed the first predetermined threshold, the computer system retrieving information about actual usage of parts of other subjects that match the first subject, wherein each of the parts matches the part of the first subject;
based on the retrieved information about the actual usage of the parts of the other subjects, the computer system determining that one or more parts included in the parts have malfunctioned and determining that the one or more parts is a portion of the parts that exceeds a second predetermined threshold; and
based on the one or more parts being a portion of the parts that exceeds the second predetermined threshold, the computer system validating the content that specifies the malfunction of the part of the first subject as being accurate, even though the first reviewer has used the part of the first subject at the frequency or the amount of usage that does not exceed the first predetermined threshold, which initially indicated that the content that specifies the malfunction was not accurate.

11. The computer program subject of claim 10, wherein the method further comprises the step of in response to the step of validating the content that specifies the malfunction as being accurate, the computer system generating and sending a notification to a manufacturer of the first subject about the part and the one or more parts having malfunctioned, which results in an identification and a repair of a defect that caused the part and the one or more parts to malfunction.

12. The computer program subject of claim 9, wherein the method further comprises the computer system designating that the content specifying a part of the subject is inaccurate, wherein the part is the aspect of the subject, wherein the step of receiving the review includes receiving the content which specifies that the part of the subject has malfunctioned on multiple occasions, wherein the step of retrieving the information about the actual usage of the aspect of the subject by the reviewer includes retrieving information collected by a sensor coupled to the subject which indicates that the reviewer has not actually used the part, wherein the step of determining whether the content specifying the aspect matches the retrieved information about the actual usage of the aspect of the subject by the reviewer includes determining that the content which specifies that the part of the subject has malfunctioned does not match the retrieved information which indicates that the reviewer has not actually used the part, and wherein the step of designating that the content specifying the part is inaccurate is based on the content which specifies that the part of the subject has malfunctioned not matching the retrieved information which indicates that the reviewer has not actually used the part.

13. The computer program subject of claim 9, wherein the method further comprises the steps of:
the computer system receiving a second review whose content specifies usage by a second reviewer of the subject is affected by an aspect of an environment of the subject;
the computer system retrieving information collected a sensor about the aspect of the environment of the subject during actual usage of the subject by the second reviewer;
the computer system determining whether the content specifying the usage of the subject being affected by the aspect of the environment matches the retrieved information about the aspect of the environment during the actual usage of the subject by the second reviewer; and
if the content specifying the usage of the subject being affected by the aspect of the environment matches the retrieved information about the aspect of the environment during the actual usage of the subject by the second reviewer, the computer system generating and transferring an indicator that indicates the content specifying the usage of the subject being affected by the aspect of the environment is accurate, or if the content specifying the usage of the subject being affected by the aspect of the environment does not match the retrieved information about the aspect of the environment during the actual usage of the subject by the second reviewer, the computer system generating and transferring an indicator that indicates the content specifying the usage of the subject being affected by the aspect of the environment is inaccurate.

14. The computer program subject of claim 13, wherein the method further comprises the step of the computer system presenting to a user the review together with (i) a first notification based on the indicator that indicates the content specifying the usage of the subject being affected by the aspect of the environment is accurate if the content specifying the usage of the subject being affected by the aspect of the environment matches the retrieved information about the aspect of the environment during the actual usage of the subject by the second reviewer or (ii) a second notification based on the indicator that indicates the content specifying the usage of the subject being affected by the aspect of the environment is inaccurate if the content specifying the usage of the subject being affected by the aspect of the environment does not match the retrieved information about the aspect of the environment during the actual usage of the subject by the second reviewer.

15. A computer system comprising:
a central processing unit (CPU);
a memory coupled to the CPU; and
a computer readable storage medium coupled to the CPU, the computer readable storage medium containing instructions that are executed by the CPU via the memory to implement a method of transferring a message, the method comprising the steps of:
the computer system receiving a review whose content specifies an aspect of a subject having multiple aspects, the review being provided by a reviewer;
the computer system retrieving information collected by one or more sensors about actual usage of the aspect of the subject by the reviewer;
the computer system determining whether the content specifying the aspect of the subject matches the retrieved information about the actual usage of the aspect of the subject by the reviewer; and
if the content specifying the aspect of the subject matches the retrieved information about the actual usage of the aspect of the subject by the reviewer, the computer system generating and transferring an indicator that indicates the content specifying the aspect of the subject is accurate, or if the content specifying the aspect of the subject does not match the retrieved information about the actual usage of the aspect of the subject by the reviewer, the computer system generating and transferring an indicator that indicates the content specifying the aspect of the subject is inaccurate.

16. The computer system of claim 15, wherein the method further comprises the steps of:
the computer system receiving a first review whose content specifies a malfunction of a part of a first subject, the first review being provided by a first reviewer;
the computer system retrieving information collected by a sensor about actual usage of the part of the first subject by the first reviewer;
based on the retrieved information about the actual usage of the part of the first subject by the first reviewer, the computer system determining the first reviewer has used the part of the first subject at a frequency or an amount of usage that does not exceed a first predetermined threshold, which initially indicates that the content that specifies the malfunction is not accurate;
based on the first reviewer having used the part of the first subject at the frequency or the amount of usage that does not exceed the first predetermined threshold, the computer system retrieving information about actual usage of parts of other subjects that match the first subject, wherein each of the parts matches the part of the first subject;
based on the retrieved information about the actual usage of the parts of the other subjects, the computer system determining that one or more parts included in the parts have malfunctioned and determining that the one or more parts is a portion of the parts that exceeds a second predetermined threshold; and
based on the one or more parts being a portion of the parts that exceeds the second predetermined threshold, the computer system validating the content that specifies the malfunction of the part of the first subject as being accurate, even though the first reviewer has used the part of the first subject at the frequency or the amount of usage that does not exceed the first predetermined threshold, which initially indicated that the content that specifies the malfunction was not accurate.

17. The computer system of claim 16, wherein the method further comprises the step of in response to the step of validating the content that specifies the malfunction as being accurate, the computer system generating and sending a notification to a manufacturer of the first subject about the part and the one or more parts having malfunctioned, which results in an identification and a repair of a defect that caused the part and the one or more parts to malfunction.

18. The computer system of claim 15, wherein the method further comprises the computer system designating that the content specifying a part of the subject is inaccurate, wherein the part is the aspect of the subject, wherein the step of receiving the review includes receiving the content which specifies that the part of the subject has malfunctioned on multiple occasions, wherein the step of retrieving the information about the actual usage of the aspect of the subject by the reviewer includes retrieving information collected by a sensor coupled to the subject which indicates that the reviewer has not actually used the part, wherein the step of determining whether the content specifying the aspect matches the retrieved information about the actual usage of the aspect of the subject by the reviewer includes determining that the content which specifies that the part of the subject has malfunctioned does not match the retrieved information which indicates that the reviewer has not actually used the part, and wherein the step of designating that the content specifying the part is inaccurate is based on the content which specifies that the part of the subject has malfunctioned not matching the retrieved information which indicates that the reviewer has not actually used the part.

19. The computer system of claim 15, wherein the method further comprises the steps of:
the computer system receiving a second review whose content specifies usage by a second reviewer of the subject is affected by an aspect of an environment of the subject;
the computer system retrieving information collected a sensor about the aspect of the environment of the subject during actual usage of the subject by the second reviewer;
the computer system determining whether the content specifying the usage of the subject being affected by the aspect of the environment matches the retrieved information about the aspect of the environment during the actual usage of the subject by the second reviewer; and
if the content specifying the usage of the subject being affected by the aspect of the environment matches the retrieved information about the aspect of the environment during the actual usage of the subject by the second reviewer, the computer system generating and transferring an indicator that indicates the content specifying the usage of the subject being affected by the aspect of the environment is accurate, or if the content specifying the usage of the subject being affected by the aspect of the environment does not match the retrieved information about the aspect of the environment during the actual usage of the subject by the second reviewer, the computer system generating and transferring an indicator that indicates the content specifying the usage of the subject being affected by the aspect of the environment is inaccurate.

20. The computer system of claim 19, wherein the method further comprises the step of the computer system presenting to a user the review together with (i) a first notification based on the indicator that indicates the content specifying the usage of the subject being affected by the aspect of the environment is accurate if the content specifying the usage of the subject being affected by the aspect of the environment matches the retrieved information about the aspect of the environment during the actual usage of the subject by the second reviewer or (ii) a second notification based on the indicator that indicates the content specifying the usage of the subject being affected by the aspect of the environment is inaccurate if the content specifying the usage of the subject being affected by the aspect of the environment does not match the retrieved information about the aspect of the environment during the actual usage of the subject by the second reviewer.
